(19) United States
(12) Patent Application Publication
(10) Pub. No.: US 2025/0354837 A1
(43) Pub. Date: Nov. 20, 2025

(54) OPTICAL SENSOR

(71) Applicant: WIKA Optical Sensing Limited, Didcot Oxfordshire (GB)

(72) Inventors: Steve Batsford, Didcot Oxfordshire (GB); Thomas Clayton, Didcot Oxfordshire (GB); Peter Elbourn, Didcot Oxfordshire (GB); Kaye Fuller, Didcot Oxfordshire (GB); Conrad Langton, Abingdon Oxfordshire (GB); Ralf-Dieter Pechstedt, Didcot Oxfordshire (GB); Mark Whitehead, Didcot Oxfordshire (GB)

(73) Assignee: WIKA Optical Sensing Limited, Didcot Oxfordshire (GB)

(21) Appl. No.: 18/721,806

(22) PCT Filed: Dec. 20, 2022
(86) PCT No.: PCT/GB2022/053333

§ 371 Date: Jun. 19, 2024

(30) Foreign Application Priority Data
Dec. 23, 2021 (GB) 2118943.6

(51) Int. Cl. G01D 5/353; G01M 15/02; G01M 15/14

(52) U.S. Cl. CPC G01D 5/35306; G01M 15/02; G01M 15/14

(57) ABSTRACT

There is disclosed an optical sensor for detecting one or more measurands such as temperature or pressure, comprising a probe light source arranged to generate probe light, and a sensor head arranged to receive the probe light from the probe light source and impose on the probe light an interference signal responsive to the one or more measurands. The sensor then also comprises an interrogator arranged to receive the probe light from the sensor head, measure the imposed interference signal, and determine the one or more measurands from the measured interference signal, and an optical fibre arranged to carry the received probe light at least some of the way from the sensor head to the interrogator, wherein the optical fibre is disposed within a protective conduit. A granular material may then be packed within the conduit so as to restrict or prevent lateral movement of the optical fibre within the conduit. The optical fibre may also or instead be disposed within one or more flexible sleeves within the conduit.

The present invention relates to optical sensors, for example optical sensors in which a sensor head imposes on probe light an interference signal responsive to one or more measurands, and in which an optical fibre carries the interference signal from the sensor head to be received by an interrogator.

### INTRODUCTION

Sensor systems using optical fibres are promising candidates for replacing or complementing conventional instrumentations in harsh environments. For instance, sensor systems based on remotely interrogated Fabry-Perot cavities can be used to monitor combustion processes in internal combustion engines such as gas turbines (see Pechstedt and Hemsley, “Fiber optical sensors for monitoring industrial gas turbines”, Handbook of Optoelectronics, Vol. 3, Ch. 18,CRC Press, Taylor & Francis Group 2018) and reciprocating engines (F. C. P. Leach et al., “An optical method for measuring exhaust gas pressure from an internal combustion engine at high speed”, Review of Scientific Instruments 88, 125004, 2017).

In those applications a passive sensor head is typically mounted in or near the combustion zone where it may be exposed to extreme vibration levels and very high temperatures. More generally, a sensor head may be mounted on a core of an engine which comprises compressor, burner, and turbine, or on an exhaust system. As a guidance, a sensor head may be typically exposed to temperatures between 400° C. and 600° C. or higher, with vibration levels reaching tens of g, where g is denoting the standard acceleration of gravity g=9.81 m/s².

Optical pressure sensors such as those described in WO2009/077727may employ a transducer element comprising a flexible diaphragm, that provides a boundary of an optical cavity, and that deforms in response to applied pressure. A sensor head comprising the transducer element is typically connected to an interrogator (or signal conditioner) via an optical cable comprising an optical fibre. The optical fibre acts as a medium to transmit probe light from the interrogator to the sensor head and back to the interrogator.

Optical interference generated by the probe light within the optical cavity produces an optical intensity of the return probe light that varies in response to applied pressure. In the interrogator, the intensity of the returned probe light is received by an optical detector such as a photo diode, the signal from which is processed to determine and output a signal representing pressure at the diaphragm which may then typically be output as a voltage or current. Different sensor head and transducer arrangements can be used to determine other measurands at the sensor head such as temperature.

The inventors have observed that the harsh environments in which such sensors are typically deployed often give rise to undesirable artefacts or biases in the interference signal which do not arise from the measurands itself. Sometimes such undesirable artefacts or biases are referred to in the prior art as being due to cross-sensitivities of the sensor. It would be desirable to reduce or eliminate such artefacts, biases and cross-sensitivities so as to improve the accuracy of determination of measurands determined by such sensors.

The invention seeks to address these and other limitations of the related prior art.

### SUMMARY OF THE INVENTION

An optical fibre may be used to carry probe light between a sensor head and an interrogator, and the inventors have identified movement of such an optical fibre as a significant contributor to artefacts and biases in the measured interference signal and therefore errors in the subsequently determined measurands such as pressure and/or temperature. Embodiments of the invention therefore aim to eliminate or further suppress such movement induced artefacts and biases in fibre optical sensors, allowing such sensors to operate more effectively and accurately in harsh environments such as extreme vibration levels and/or high operating temperatures, for example as found in typical gas turbine or reciprocating engine applications.

The invention therefore provides an optical sensor for detecting one or more measurands such as pressure and/or temperature, comprising: a probe light source arranged to generate probe light; a sensor head arranged to receive the probe light from the probe light source and impose on the probe light an interference signal responsive to the one or more measurands; an interrogator arranged to receive the probe light from the sensor head, measure the imposed interference signal, and determine the one or more measurands from the measured interference signal; an optical fibre arranged to carry the received probe light at least some of the way from the sensor head to the interrogator, at least a portion of the length of the optical fibre being disposed within a protective conduit; and a granular material packed or filled within the conduit so as to restrict or prevent lateral movement of the optical fibre within the conduit.

However at the same time, the granular material is preferably packed or filled within the conduit so as to permit longitudinal movement of the optical fibre within the conduit, thereby allowing for thermal expansion differences without inducing undue strain on the optical fibre. To this end, the granular material may be packed or filled fairly loosely, without much or any compression, but preferably avoiding any significant voids or gaps which could lead to instabilities and movement of the optical fibre within the conduit when the sensor is deployed.

Typically, the probe light source and interrogator (which may comprise the probe light source) may be located a significant distance from the sensor head, for example at a distance of several metres or even tens of metres, with at least some of the optical coupling between the two being provided by the optical fibre.

The conduit may comprise an elongate tube or corrugated hose, or portions of the conduit may be provided by either or both of one or more elongate tubes and one or more corrugated or flexible hoses suitably joined, with either or both typically being made of metal. In this way, more rigid sections may be provided by metal tubing, with more flexible sections being provided by corrugated metal hosing, as desired according to the application area and particular installation constraints.

The conduit may typically have an inside diameter of from 2 mm to 10 mm, or from 1 mm to 20 mm. The length of conduit containing the optical fibre may typically extend for between 100 mm and 3000 mm from the sensor head, or from close to or proximal to the sensor head. Different elongate sections of the conduit may have different inside diameters, for example a rigid section may have a different internal diameter to a flexible section.

The conduit may extend from the sensor head to a junction which comprises an optical connector between a first portion of the optical fibre contained in the conduit and a second portion of the optical fibre extending further towards the interrogator from the junction. The junction may then comprise a slack section of the first portion of the optical fibre arranged to accommodate movement of the first portion of the optical fibre along the conduit. In this way, some thermal mismatch between the optical fibre and the conduit can be accommodated without imposing further strain on the optical fibre within the conduit, at the sensor head, or at the junction.

The granular material may comprise a ceramic granulate or ceramic powder, and in particular an engineering ceramic granulate or powder. In order to provide suitable properties for pouring or filling into the conduit and stable positioning of the optical fibre, the granular material may have an average or median particle size in the range of from 10 μm to 200 μm, or from 30 μm to 80 μm.

Whether or not the granular material is provided within the conduit as mentioned above, the optical fibre may be disposed within a flexible sleeve which is disposed within the conduit, or within a plurality of coaxial flexible sleeves disposed within the conduit, wherein each flexible sleeve may comprise a braided, knitted or woven material, or a material of some other textile construction. If multiple, coaxial flexible sleeves are used, each sleeve of the coaxial combination may be formed using a different such textile construction. Note than when coaxial sleeves are referred to, these need not be concentric in the sense of having exactly the same central point, but could be offset to some extent while still being nested one within another. If a granular material is also provided, this may be packed between any of the conduit, the optical fibre, and one or more of the sleeve layers.

If two coaxial flexible sleeves are used, an inner one of the coaxial flexible sleeves may formed from a woven textile material and an outer one of the coaxial flexible sleeves from a knitted or braided textile material, so that the inner woven sleeve provides better protection for the optical fibre from potential deformation by the outer layer which serves to fill the volume outside the woven layer so as to better restrict movement of the optical fibre. Alternatively, an inner one of the coaxial flexible sleeves maybe formed from a braided textile material and an outer one of the coaxial flexible sleeves from a woven textile material. The braided material may thereby better permit longitudinal movement of the optical fibre through its smoother surface in direction of the fibre axis.

If the conduit comprises a plurality of elongate sections through which the optical fibre passes, for each such elongate section the optical fibre may be disposed within a different combination of two or more coaxial flexible sleeves which are disposed within that section of the conduit. In this case, each sleeve of each combination may be of a particular textile construction type, and each different combination may then comprise a different sequence of two or more such textile construction types. For example, in a smaller diameter section of the conduit coaxial woven and braided flexible sleeves may be used, while in a larger diameter section coaxial woven and knitted flexible sleeves may be used.

A silica material may typically be used for the, or each, flexible sleeve, for example comprising at least 95% or at least 99% silica. If the granular material is being used it may then be packed or filled either within a particular flexible sleeve, around the outside of a particular flexible sleeve, or both.

If the granular material is packed in layers both within a flexible sleeve and around the outside of a flexible sleeve, then two types of granular material may be used such that the granular material within the flexible sleeve is of a different type or has different properties to the granular material around the outside of the flexible sleeve. In such as case, the granular material within the flexible sleeve may have a lower coefficient of thermal expansion than the granular material around the outside of the flexible sleeve, to help accommodate the optical fibre having a lower coefficient of thermal expansion than the conduit.

A typical optical fibre used in the prior art for similar sensors typically has a diameter, or a cladding outside diameter, of 125 μm. Whether or not the granular material mentioned above is used, and whether or not the flexible sleeve above is used, the optical fibre, or the cladding layer of the optical fibre, may have an enhanced diameter, or an enhanced outside diameter, of at least 150 μm, or of at least 200 μm, or of at least 250 μm. Increasing the fibre diameter or the outside diameter of the cladding in this way increases the stiffness of the optical fibre, thereby helping to further reduce bending and movement within the conduit. The optical fibre of enhanced outside diameter may in particular be a single mode optical fibre.

Whether or not the granular material mentioned above is used, and whether or not one or more flexible sleeves above are used, and whether or not the enhanced diameter cladding layer of the optical fibre above is used, the optical fibre may be a single-mode fibre having a reduced mode field diameter so that any bending of the optical fibre within the conduit has a reduced effect on the interference signal being carried from the sensor head to the interrogator. In particular, the optical fibre may be arranged to have a mode field diameter of no more than 10.0 μm, or no more than 8.0 μm, or in the range 6.0 μm to 8.0 μm. Since mode field diameter varies according to wavelength of the probe light, these values of mode field diameter may be defined to be at a central wavelength of the probe light, for example a peak or average wavelength.

For typical infrared probe light, for example in the region of about 1300 to 1800 nm or from 1400 to 1700 nm, to achieve a suitable range of mode field diameter, the optical fibre may have a core diameter of from 5 μm to 7 μm, and a numerical aperture of from 0.16 to 0.20.

To reduce bending losses or similar effects, instead of or as well as using a reduced mode field diameter, particular optical fibre structures may be used, for example a holey fibre such as a photonic bandgap fibre or an average index guided fibre may be used, or an optical fibre may be used which has a multi-layered core region comprising an annular trench of depressed index surrounding a central core having a raised step-index profile.

The probe light source may comprise one or more lasers, or one or more super-luminescent diodes, arranged to generate the probe light. The wavelength characteristics of the probe light may depend on how the sensor is arranged to measure and use the imposed interference signal. For example, the interrogator may be arranged to separately detect the intensities of two different wavelengths or wavebands of the probe light received from the sensor head, and to determine one or more of the one or more measurands responsive to a relationship between the detected intensities of the two wavelengths or wavebands. In this case probe light of two distinct wavelengths or wavebands is required, which could for example be provided by two lasers, a single tuneable or swept laser, a single broad band light source in conjunction with two optical filters with high transmission characteristics at the two wavelengths, or two super-luminescent diodes with their respective central (such as peak or average) wavelengths chosen such that they match the two required wavelengths or wavebands.

Alternatively, the interrogator may comprise a spectral engine or spectrometer arranged to measure an interference spectrum comprising the imposed interference signal, and may then be arranged to determine one or more of the one or more measurands from the measured interference spectrum, in which case a broad band probe light is required, for example being provided by a super-luminescent diode or a swept laser source.

The sensor head may comprise one or more optical cavities arranged to impose the interference signal on the probe light responsive to the one or more measurands. One or more or all of these optical cavities may be Fabry-Perot cavities. The one or more measurands may comprise one or more of: temperature, pressure (for example static pressure, or pressure changes at acoustic frequencies), and acceleration, at the sensor head, and the optical cavities may then be arranged to suitably respond to these measurands, such that changes in these optical cavities are detectable in the interference signal.

The sensor may be used to determine the one or more measurands at, on or in various types of engines, such as internal combustion or gas turbine engines. To this end, the invention also provides a gas turbine engine or internal combustion engine comprising one or more of the optical sensors of any preceding claim. The optical sensor may then in particular be arranged to detect combustion instabilities in the gas turbine or other type of engine.

The invention also provides methods corresponding to the above apparatus, including methods of operating and methods of constructing or manufacturing such apparatus.

The invention therefore provides a method of detecting one or more measurands, comprising: generating probe light; directing the probe light to a sensor head arranged to receive the probe light from the probe light source and impose on the probe light an interference signal responsive to the one or more measurands; and receiving the probe light with the imposed interference signal from the sensor head along an optical fibre, and measuring the imposed interference signal, wherein the optical fibre is disposed within a protective conduit.

The conduit may then contain the above mentioned granular material so as to restrict lateral movement of the optical fibre within the conduit, and/or the optical fibre may be contained within the above-mentioned flexible sleeve or multiple coaxial flexible sleeves within the conduit, and/or the optical fibre may comprise a cladding of enhanced outside diameter for example as discussed above, and/or the optical fibre may have a reduced mode field diameter for example as discussed above, noting that the optical fibre may be a single mode optical fibre.

The method may then further comprise determining the one or more measurands from the measured interference signal.

The invention also comprises a method of providing or making or manufacturing an optical sensor as described herein, including a method comprising: providing an optical fibre to couple probe light from a sensor head to be received by an interrogator that is arranged to measure an interference signal imposed on the probe light by the sensor head responsive to the one or more measurands; locating at least a portion of the optical fibre in a protective conduit; and one or more of: providing the granular material within the protective conduit, providing the one or more flexible sleeves coaxially around the optical fibre within the conduit, providing the optical fibre with an increased cladding diameter, and providing the optical fibre with a reduced mode field diameter.

### BRIEF SUMMARY OF THE DRAWINGS

Embodiments of the invention will now be described, by way of example only, with reference to the accompanying drawings, of which:

FIG. 1 schematically shows a sensor according to the invention using a granular material within a conduit carrying an optical fibre;

FIG. 2 illustrates in more detail how the sensor head and optical fibre of FIG. 1 may be implemented;

FIGS. 3 to 7, 8a and 8b illustrate in cross section ways in which the conduit and carried optical fibre of FIGS. 1 and 2 may be implemented;

FIG. 9 presents a graph of sensitivity of a described sensor arranged to measure pressure, to incidental vibration, when the sensor is implemented both with (lower curve) and without (upper curve) the granular material within the conduit;

FIG. 10 illustrates how increasing the cladding diameter of the optical fibre can increase stiffness and reduce sensitivity to vibration or movement of the optical fibre within the conduit;

FIG. 11 illustrates in cross section how the conduit and carried optical fibre can be implemented with a flexible sleeve, but without the use of granular material within the conduit; and

FIG. 12 shows how mode field diameter of an optical fibre such as that of the other figures varies with core diameter and numerical aperture (NA).

### DETAILED DESCRIPTION OF EMBODIMENTS

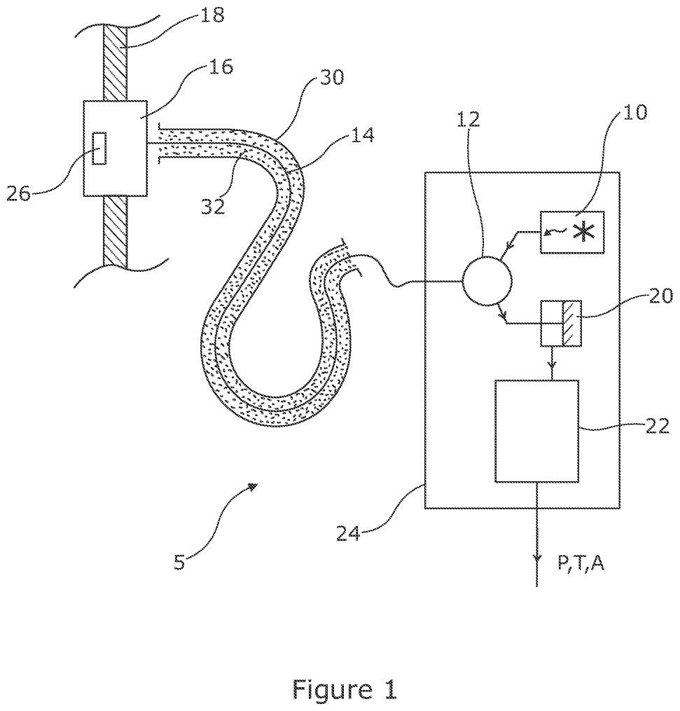

Referring now to FIG. 1 there is shown schematically an optical sensor 5 which may embody various aspects of the invention. A probe light source 10 generates probe light which is coupled via an optical coupler 12 to an optical fibre 14 (typically a single mode optical fibre) which directs the probe light to a sensor head 16. The sensor head 16 may be mounted in a harsh environment, for example in a wall 18 of a gas turbine or other engine, often flush with the inside of the wall rather than protruding as shown in FIG. 1. The harsh environment may for example be characterised by high temperatures perhaps of several hundred degrees Celsius, may be subject to high intensities of vibration, and so forth.

The sensor head 16 is arranged to impose on the probe light an interference signal which is responsive to one or more measurands at the sensor head, for example one or more of temperature T, static or dynamic pressure P, acceleration A and so forth. As shown in FIG. 1, the sensor head may be arranged to respond to such measurands within a space such as within the wall 18 of a chamber of a gas turbine or other engine. The probe light now carrying the interference signal is then returned from the sensor head 16 along the optical fibre 14 to the optical coupler 12 from where it is directed to an optical detector 20 where the interference signal is measured.

The measured interference signal is then passed to an analyser 22 which uses the measured interference signal to determine values of, or signals representing, the one or more measurands which are then output or used in various ways. Such signals could be in the form of voltages or currents representing the measurands, corresponding digital data signals, or in other forms.

In FIG. 1, the light source 10, optical coupler 12, optical detector 20 and analyser 22 are shown as housed in or forming part of an interrogator unit 24, although these or related functions or elements may be housed or distributed in different ways. Although in FIG. 1 single optical fibre 14 is used to carry probe light from the light source towards the sensor head 16, and from the sensor head towards the detector 20, two different optical fibres could be used for these purposes. Various other configurations of one or more probe light sources, one or more sensor heads 26, and one or more optical detectors 20 may also be used. For example, one or more sensor heads could be arranged to operate in a transmission rather than reflection mode, for example using Mach-Zehnder or Bragg grating interferometry techniques. Multiple such transmission or reflection geometry sensor heads could be daisy chained together for coupling to a single interrogation unit, for example with the probe light travelling out and back along the daisy chain with the sensor heads coupled using single optical fibres for both directions or different optical fibres for each direction, or in a ring configuration.

Some examples of how the sensor head 16 and interrogator 24 or associated elements may be implemented are set out in WO2009/077727, WO2012/140411, WO2013/136071 and WO2013/136072. Some other particular examples of how the sensor head itself may be implemented are provided in WO2013/024262. The contents of each of these documents is hereby incorporated by reference for these and all other purposes.

The probe light may be narrow band in nature, for example generated using one or more laser sources comprised in or forming the probe light source 10, or broadband in nature, for example using one or more swept laser sources, or generated using one or more super-luminescent diodes typically with a bandwidth of a few tens of nanometers which are comprised in or form the probe light source. In some embodiments, as discussed in more detail below, the probe light may comprise two or more different, discrete, frequencies, wavelengths or wavebands for example using a probe light source comprising two super luminescent diodes with sufficiently spaced central wavelengths for the wavebands not to overlap, or a single super luminescent diode in conjunction with two optical filters, each of which could have a bandwidth of some 10 to 20 nm.

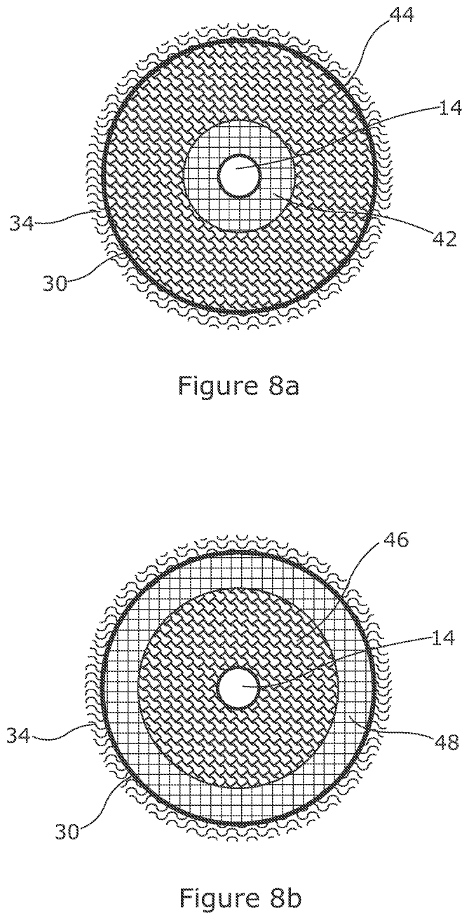

The interference signal may be imposed on the probe light by one or more structures in the sensor head such as one or more optical cavities 26. Such optical cavities may for example be Fabry-Perot cavities. Each such optical cavity is typically defined by two substantially parallel refractive index boundaries within the sensor head, for example boundaries between solid material and a gas or vacuum, and as such each such optical cavity may comprise solid material, a gas or vacuum, or both. In other embodiments the interference signal may be imposed on the probe light using one or more Michelson type interferometer structures, for example see FIG. 8b and the related text of GB2495518, the contents of which is hereby incorporated by reference for these and all other purposes.

Such optical cavities 26 and other interference structures may for example respond to temperature at the sensor head by expansion and/or refractive index change of material of the sensor head, to pressure by movement of a diaphragm a boundary of which forms a boundary of such an optical cavity, to acceleration by movement of a proof mass, or in various other ways.

The interference signal may be measured by the interrogator and used to determine one or more of the one or more measurands in various ways. According to a “dual-wavelength” technique also mentioned elsewhere in this document, the probe light source 10 is arranged to provide probe light at two different wavelengths or wavebands, for example using suitably arranged laser or super-luminescent diode sources. The sensor head then imposes an effectively separate interference signal on the probe light of each wavelength or waveband. When the probe light is received back at the interrogator from the sensor head, the two wavelengths or wavebands are then separately detected, for example by two different photodetector components of the optical detector 20 to provide separate detection signals. The analyser 22 then receives these detection signals, which may for example represent intensities of the two different wavelengths or wavebands at the optical detector, and determines one or more of the one or more measurands responsive to a relationship between, for example by a comparison of, the detection signals of the two wavelengths or wavebands.

Such techniques are discussed in the prior art such as in GB2202936 and WO2013/136072, the contents of which are hereby incorporated by reference for these and all other purposes. This “dual-wavelength” type technique provides compensation of intensity or power losses which may be present in the optical system that could otherwise be interpreted as a measurand signal, for example due to bending of the optical fibre 14. However, the inventors have found that such compensation is not generally sufficient to eliminate artefacts and biases due to the harsh environment the optical fibre 14 may be exposed to.

The interference signal may also or instead be measured by the interrogator and used to determine one or more of the one or more measurands using a spectral scheme, For example, the optical detector 20 may comprise a spectral engine arranged to measure an interference spectrum comprising the imposed interference signal, and the analyser 22 may then be arranged to determine one or more of the one or more measurands from the measured interference spectrum. Such techniques are also discussed in the prior art such as in WO2013/136072, the contents of which are hereby incorporated by reference for these and all other purposes. However, as for the dual-wavelength technique discussed above, it can remain difficult to eliminate artefacts and biases due to the harsh environment the optical fibre 14 may be exposed to.

The optical fibre 14 carrying probe light from the sensor head 16 back towards the optical detector 20 for detection of the interference signal may be formed from a single length of optical fibre, or two or more lengths coupled together, as required. In some examples, multiple optical fibres could be used, for example with different optical fibres carrying the probe light to the sensor head, and away from the sensor head.

As shown in FIG. 1, at least a portion of the optical fibre 14 is disposed within a protective conduit 30 which protects the optical fibre from damage and also from adverse environmental conditions, and especially such adverse conditions which may be experienced by the optical fibre 14 close to the sensor head 16. Such adverse conditions may include for example high temperatures, excessive vibration, and so forth. Typically, the conduit may extend from the sensor head, or from close to the sensor head, for a length of between about 0.1 and 3.0 metres, or more preferably between about 0.2 and 2.0 metres, along the optical fibre, although longer extensions may be used if required.

If multiple optical fibres are used to connect a sensor head 16 to an interrogator 24 (for example using different fibres for carrying light in each direction of for other purposes) then these may be carried together in the same conduit, or multiple optical fibres may be carried in a single conduit 30 for other purposes.

The conduit is typically provided by a tube, pipe, or similar elongate structure, for example with an inside diameter of from 2 to 10 mm, or from 1 to 20 mm, and in particular may be designed to be flexible along at least some of its length so as to assist in installation of the sensor. Such flexibility may be provided by one or more portions, or the whole of the conduit, comprising a flexible metal hose, for example a corrugated metal hose. If some or all sections of the conduit are rigid, these may comprise more rigid metal tubing. Suitable metals for the conduit may include austenitic stainless steels and nickel-chromium alloys, but non-metals such as suitable ceramic materials may also or instead be used. Further discussion of how the conduit may be implemented is provided later below.

The inventors have found that lateral movement (i.e. towards and away from the conduit walls) of the optical fibre 14 within the protective conduit 30 can give rise to unwanted artefacts, biases, or cross-sensitivities in the measured interference signal, and therefore also errors within the determined measurands. More generally, properties of the probe light propagating through the optical fibre may be affected by external stimuli acting upon the conduit 30. The resulting variations in the properties of the probe light received at the optical detector 20, and/or resulting variations in the interference signal may then be misinterpreted as due to changes in the measurands. For example, changes in bending radius of optical fibre, either in a static or slow moving sense, or as vibrational movements, may induce variations in propagation losses in the optical fiber, which themselves may also be wavelength dependent. Such changing propagation losses may then lead to a variation of light intensity received at the interrogator at particular or multiple wavelengths, and a corresponding perceived change in a measurand. Where a dual wavelength interrogation technique is used, as discussed elsewhere in this document, different propagation losses between the two wavelengths or wavebands gives rise to errors in the determined measurands(s).

Some strategies are already known in the prior art to mitigate such effects, such as the “dual-wavelength” strategy mentioned above, and discussed in GB2202936A, the contents of which are hereby incorporated by reference for these and all other purposes. This document proposes to send to a sensor head probe light comprising at least two wavelength components, to separately measure an interference signal arising from pressure changes at the sensor head at each of the two wavelengths, and to ratio the two signals to arrive at a corrected pressure response. The rationale behind this is that two different wavelength components propagating along an optical fibre are attenuated by a similar amount when the fibre is bent, meaning that the ratio of responses is largely independent of the bending and solely a function of applied pressure.

Such an interrogation scheme employing two wavelength or waveband components or probe light may be referred to as ‘dual wavelength interrogation’, which is discussed in more detail in A. Winterburn et al., “Extension of an optical dynamic pressure sensor to measure temperature and absolute pressure in combustion applications,” The Future of Gas Turbine Technology, 6^{th} International Conference, 17-18 Oct. 2012, Brussels, Belgium, Paper ID Number: 15.

However, common-mode rejection provided in this way does not guarantee complete elimination or, depending on application, sufficient suppression of artefacts and biases in the interference signal, leaving residual undesirable effects. For instance, effects on the probe light propagating in the fibre such as bending induced losses are generally a function of wavelength, creating a small differential loss between two wavelengths or wavebands of probe light used. As a result, an intensity ratio between probe light at two different wavelengths or wavebands is not only a function of measurands at the sensor head, but can also be affected by external stimuli such as vibration induced bending or movement of the optical fibre 14.

As shown in FIG. 1, in order to reduce or eliminate such artefacts and biases, a granular material 32 may be packed within the conduit 30 so as to restrict or prevent movement of the optical fibre within the conduit, especially lateral movement transverse to the axis of the conduit. Preferably, the granular material is provided and packed within the conduit sufficiently loosely so as to continue to permit essentially unrestricted longitudinal movement of the optical fibre, i.e. along a central axis of the conduit and/or along the direction of the optical fibre itself, while avoiding gaps and unfilled pockets which are then likely to permit lateral movement of the optical fibre or other less stable configurations within the conduit. In this way, relative longitudinal movement of the conduit and the optical fibre itself, especially due to thermal expansion and contraction of the conduit and/or the optical fibre, is still enabled thereby avoiding undue changes in strain within the optical fibre due to such effects.

The granular material may be packed within the conduit for example by a pouring technique, optionally including some level of agitation of the conduit to help ensure that no significant, unintentional voids are left unfilled by the granular material. It may be desirable to use other techniques to ensure an adequate packing density for example by use of a gas flow to carry the granular material along the conduit during the filling process.

The granular material may for example be or may comprise a ceramic granulate, or engineering ceramic granulate, for example comprising alumina (Al₂O₃) or magnesium oxide (MgO). The granularity of the material should be appropriate for packing around the optical fibre, whether or not enclosed within a sleeve as discussed below, such that a granular material with an average or median particle size in the range from 10 μm to 200 μm, or from 30 μm to 80 μm, may be used. Further discussion of suitable granular materials is provided later below.

Other structures may also or instead be used within the conduit to protect and/or restrict movement of the optical fibre, for example the optical fibre may be disposed within a sleeve, or within a plurality of coaxial sleeves, which are disposed coaxially within the conduit. Each such coaxial sleeve, typically provided as aa flexible and/or a textile sleeve, may be constructed using one of several different types of textile construction to provide, for example, a braided, a woven, or a knitted sleeve. Such a sleeve may for example be disposed between the optical fibre packed granular material, and/or disposed between packed granular material and the conduit, and/or disposed between two bodies of packed granular material such as a first body of packed granular material which surrounds the optical fibre and a second body of packed granular material which surrounds the sleeve. Such a sleeve may for example comprise braided, woven, or knitted, silica material, or a braided, woven, or knitted form of another ceramic. In some embodiments, one of more such coaxial sleeves surround the optical fibre but without any packed granular material being used.

By providing one or more such sleeves, each comprising a layer formed using any of several different textile construction types to provide corresponding material types to best suit the application, different desirable properties of the corresponding one or more sleeves alone or in combination may result.

For example, a braided sleeve may typically be formed by intertwining a number of strands at non-right angles, the resulting acute angle thus defining some preferred direction offering a potentially smoother surface in the direction along the axes of the conduit and the sleeve, thereby reducing friction between the sleeve and another surface such as the optical fibre.

A woven sleeve may typically consist of two sets of straight strands that are interlaced substantially at right angles, the strands themselves typically consisting of layers of individual, parallel laid fibres. As such, woven sleeves are typically somewhat stiffer than braided sleeves, providing a better mechanical protection of the optical fibre, whilst still facilitating movement of the optical fibre along the axes of the conduit and the sleeve and restricting lateral movement of the optical fibre within the conduit.

A knitted sleeve may typically be formed by strands formed into loops, the loops in turn being interlocked by further looping into a structure, resulting in a generally more flexible material. In a knitted sleeve, larger diameter strands may be utilized without losing undue flexibility, enabling a larger volume between the optical fibre and the conduit to be filled by the sleeve.

Regardless of the textile construction or sleeve material type, the strands themselves may typically consist of silica (for example quartz) fibres that are, for example, twisted or laid parallel to form a yarn or thread, respectively. Different textile construction or sleeve material types may also exhibit different mechanical damping properties, with looser and more flexible layers typically enabling stronger damping. Stronger damping may be beneficial for additional cushioning the optical fibre within the conduit, hence helping to reduce lateral movement of the optical fibre without affecting movement along the sleeve axis.

Additional damping can be achieved by embedding the flexible sleeve or sleeves within a mineral wool. Mineral wools are typically made by spinning or drawing a molten mineral material, and as such, are usually resistant to very high temperatures.

Note that in some embodiments, the granular material may be omitted altogether, but one or more flexible sleeves still used to surround the optical fibre within the conduit, so as to provide some level of restriction of lateral movement of the optical fibre as well as some level of protection beyond that provided by the conduit itself.

Further discussion of how such sleeves for example of braided silica may be used is provided later below.

In order to further limit movement, and especially lateral movement, of the optical fibre within the conduit, the stiffness of the optical fibre itself may be enhanced. This can be achieved in various ways, but in some embodiments an optical fibre 14 with an increased outside diameter, or with a cladding having an increased outside diameter, may be used. The most commonly used optical fibres have a cladding with an external diameter of about 125 μm. To further enhance the stiffness and thereby reduce artefacts and biases in the interference signal and therefore reduce errors in the determined one or more measurands, an optical fibre having a diameter, or an outside cladding diameter, of at least 150 μm, or of at least 200 μm, or of at least 250 μm may be used, noting that the optical fibre may be a single mode optical fibre.

In order to reduce the magnitude of artefacts and biases such as bending losses in the probe light and interference signal which arise from a particular degree of movement of the optical fibre within the conduit, and especially lateral movement within the conduit, the mode field diameter of the optical fibre may be reduced. The mode field diameter of a particular optical fibre is dependent on the wavelength of the light within the optical fibre, in this case the wavelength(s) of the probe light, but for a suitable infrared wavelength of around 1550 nm for the probe light, a typical step-index single-mode optical fibre may have a core diameter of 9 μm, a mode field diameter of about 10.6 μm, and a numerical aperture of about 0.12. To reduce artefacts and biases such as bending losses, the optical fibre 14 may therefore be provided so as to have a mode field diameter of no more than 10 μm and more preferably no more than 8 μm at the wavelength, or at a, or the, central wavelength (which may be a peak or average wavelength) of the probe light.

Where a broadband or multiple wavelength or waveband probe light source is used, such a central wavelength may be defined for example as the wavelength of a principle or main peak of the probe light, or an average wavelength with respect to the optical power across the spectrum of the probe light. A broadband source may typically have a spectral width of a few tens of nm.

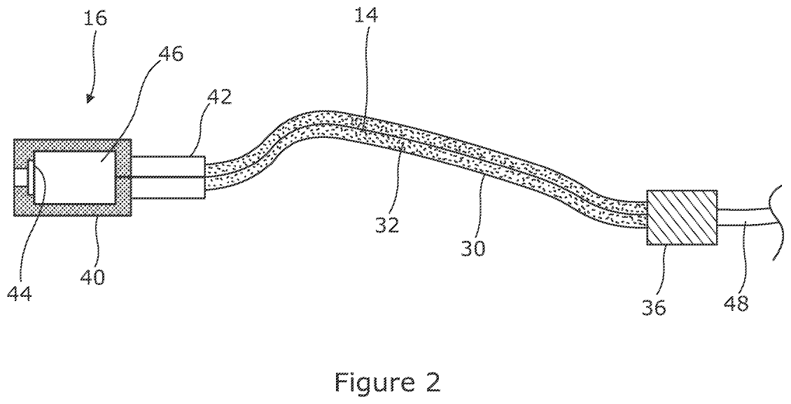

FIG. 2 shows in more detail how the sensor head 16 and at least a portion of the optical fibre 14 connecting with the interrogator 24 as shown in FIG. 1 may be implemented. In FIG. 2 the conduit 30 containing the optical fibre 14 extends from the sensor head 16 to a junction 36. The sensor head and the part of the conduit that is nearest to the sensor head are typically exposed to the most extreme temperatures and/or vibrations.

The sensor head 16 as shown in FIG. 2 comprises a sensor housing 40, an optional rigid section 42, a transducer element 44 and an optical coupling arrangement 46 which optically couples between the optical fibre 14 and the transducer element 44. The sensor housing 40 provides protection to the internal parts of the sensor head 16 and enables mounting of the sensor head, for example through an aperture in the liner of a gas turbine. A preferred material for the housing 40 may be a high-performance Nickel-Chromium alloy. For example, Inconel 625 may be a preferred choice due to its excellent mechanical properties such as high tensile, rupture and creep strength that are maintained over a wide range of operating temperatures.

The transducer element 44 provides a transducer mechanism whereby one or more measurands are encoded onto the probe light. For example, in a pressure sensor that is based on interferometry the transducer element 44 may comprise a flexible diaphragm that is part of an optical cavity and which deflects in response to applied pressure. The flexible diaphragm provides one of the two parallel reflecting surfaces of the optical cavity, whereby the second reflecting surface is provided by a rigid member of the transducer element 44 opposite the diaphragm. Probe light that is impinging on the optical cavity is split into two return beams at the two reflecting surfaces of the optical cavity, creating an interference pattern once recombined. Application of pressure causes changes to the distance between the two surfaces, leading to a change of interference pattern and a resulting variation of intensity of the reflected probe light.

The reflected probe light therefore carries the pressure information as light intensity. For intended operations at high temperatures, the transducer element may be preferably formed entirely of Sapphire, as taught, for example in WO2009/077727, the contents of which are hereby incorporated by reference for these and all other purposes.

The coupling arrangement 46 provides for optical coupling between the probe light in the optical fibre 14 and the transducer element 44. For example, the optical fibre may be attached to a lens (not shown) and probe light propagating in the optical fibre towards the transducer element 44 is then collimated by the lens and directed towards the transducer element. The probe light is then reflected back from the transducer element, recaptured by the lens and re-launched into the optical fibre 14 where it propagates back to the interrogator 24. For intended operation at extreme temperatures at the sensor head 16 of towards 1000° C. and above, the lens and adjacent or attached end of the optical fibre may preferably be located at a certain minimum distance from the transducer element 44. Such a distance may be provided by a spacer, for example as described in WO2009/077727. In that way, a sapphire based transducer element 44 may be exposed to extreme temperatures of 1000° C. and above, whereas the lens and optical fibre which conveniently may be formed of silica can be kept at a lower temperature. Typically, silica fibre should not be exposed to temperatures above the order of 700° C. for prolonged periods of time to avoid, for example, damage of the fibre coating or degradation of performance like out-diffusion of dopants from the core region into the cladding. In some arrangements however, the optical fibre may be attached to the sensor element directly without a spacer and without a lens, or just with a lens.

An optional rigid section 42 may be provided as part of the sensor head 16, extending away from the housing 40 and surrounding the optical fibre, typically for additional mechanical protection during handling and/or installation. A typical length of the rigid section may be between 10 mm and 200 mm. The rigid section may be straight or bent.

Beyond or coupled to the rigid section, the conduit 30 is provided to protect the optical fibre and to serve as an external armour which is typically long enough to extend into a more benign environment, for example extending along and containing the optical fibre for between 100 mm and 3000 mm from the sensor head. Typically, the conduit 30 is required to exhibit some degree of large-scale mechanical flexibility to enable routing of the conduit as required, for instance, during installation. To this end, the whole or parts of the conduit may be designed to be flexible, for example comprising or being provided by a corrugated metal hose. However, one or more section, or all of the conduit may be rigid if required, for example comprising or being provided by relatively rigid sections of metal tubing.

An austenitic stainless steel may be a suitable material choice for the conduit or corrugated metal hose because of its good mechanical properties and high corrosion resistance. Alternatively, a Nickel-Chromium alloy based conduit or corrugated metal hose such as made from Inconel may be employed.

In some applications the whole length of the conduit or one or multiple sections of the conduit may be rigid. The one or multiple rigid sections of the conduit may be straight or may be pre-bent prior to installation to enable a predefined routing. A typical length of the conduit section may be between about 100 mm and 3000 mm. One or more portions, or all of the conduit, and especially any flexible sections of the conduit may additionally be protected by a metal braiding on the outside of the conduit.

The junction 36 at the end of the conduit 30 opposite to the sensor head 16 provides an optical interface that enables coupling of a first portion of the optical fibre 14 to a second portion of the optical fibre provided within an optical extension cable 48, typically via an optical connector forming part of the junction. The optical extension cable 48 then provides extension of the optical fibre 14 to the interrogator 24. The junction 36 may be of different geometrical shapes, for example in the shape of a box or a tube. A complete sensor system may therefore comprise an interrogator 24 and one or more optical sensor assemblies each comprising a sensor head 16, conduit 30, junction 36, and one or more extension cables 48 connecting each of the sensor assemblies to the interrogator.

The junction 36 may accommodate an additional amount, or slack section of optical fibre arranged to permit some movement of the optical fibre within and along the axis of the conduit, to account for the thermal expansion mismatch between the optical fibre and the conduit. By way of example, consider a 1000 mm long flexible conduit made of stainless steel 316 with a coefficient of thermal expansion (CTE) of αₛₛ₃₁₆˜15×10⁻⁶/° C. Optical fibre on the other hand is typically made of fused silica with a CTE α_{silica}˜0.5×10⁻⁶/° C. Hence, a temperature increase ΔT of 100° C. across L=1 m length of conduit would generate a differential length increase of ΔL=L(αₛₛ₃₁₆−α_{silica})ΔT=1 m×(15−0.5)×10⁻⁶/° C.×100° C.=1.45 mm. A similar thermal mismatch may arise between the optical fibre and a rigid conduit section consisting, for example of Inconel 625 with a similarly large CTE of around ˜13×10⁻⁶/° C.

If no slack section is provided, restricting movement of the optical fibre within the conduit along its axis, the mismatch may lead to accumulation of stresses within the optical fibre, that can result in damage or breakage of the fibre. Even damage that may initially not being apparent can lead to a complete failure of the fibre over time or during repeated temperature cycling as it is the case for gas turbines that are being operated under changing load conditions for example dictated by the need of the power grid.

The requirement to allow movement of the optical fibre 14 along its own axis and the axis of the containing conduit, especially for such a conduit that will be bent or flexed for routing purposes during installation usually requires the internal diameter of the conduit to be substantially larger than the optical fibre diameter, for example having an internal diameter or largest internal dimension of from 2 mm to 10 mm or from 1 mm to 20 mm. As a result, when the sensor head and conduit are subject to vibrations, the optical fibre would experience lateral movements perpendicular to its axis in the conduit, leading to vibration induced bending losses that may manifest themselves as spurious measurand signals.

Some embodiments of the invention therefore employ a powder filler or granular material aiming to eliminate the lateral mechanical movements of the optical fibre within the conduit caused by vibrations, whilst allowing for axial movement of the fibre to enable compensation of the thermal expansion mismatch between the fibre and the conduit for a conduit that is flexible enough for routing purposes during installation of the sensor.

To this end, a powder or other granular material 32 of suitable material and consistency may be introduced to fill the space between the optical fibre 14 and the conduit 30 as shown in FIG. 2 and also in the earlier discussed FIG. 1. The use of a suitable powder filler or other granular material 32 enables to completely fill the entire space between the optical fibre and the walls of the conduit without leaving any voids. Lateral movement of the fibre within the conduit perpendicular to its axis is therefore effectively eliminated, significantly reducing vibration induced artefacts or biases in the probe light signal due to bending effects of the fibre within the conduit. On the other hand, the optical fibre can still move along its axis and along the axis of the conduit while being embedded in a powder or granular material 32 of suitable consistency, enabling the compensation of thermal expansion mismatch between the optical fibre and the conduit.

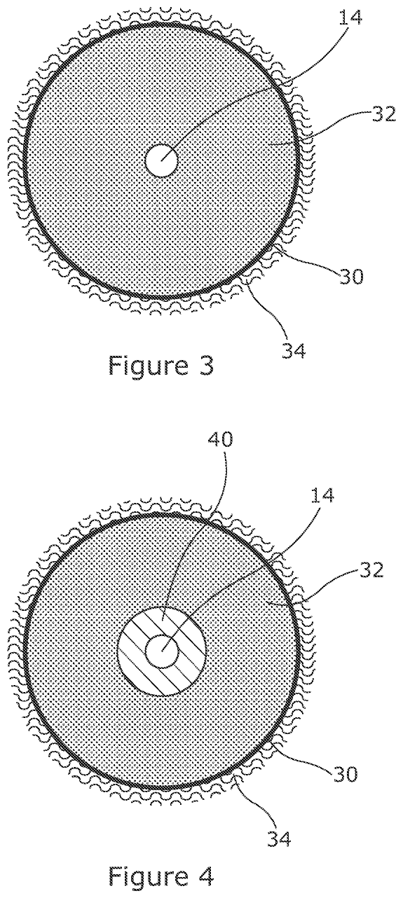

FIG. 3 shows a cross section through the flexible conduit 30 of FIG. 2. The optical fibre 14 is embedded within, and in this case, in contact with, the granular filler material 32 packed within the conduit 30. It should be noted that, advantageously, the addition of such a granular material 32 should not unduly restrict the ability to bend the flexible conduit 30, as may be required for instance during installation, as long as the packing of the granular material is sufficiently loose, for example filled within the conduit so as to avoid voids and gaps, but without using significant compression or force.

In FIG. 3 the optical fibre is positioned centrally within the conduit, so that the conduit, the region of granular material, and the optical fibre, are substantially concentric, although other arrangements are possible. For example, the optical fibre could be off centre within the conduit, but within, say 10% of the conduit diameter from the central axis of the conduit. Ensuring that the optical fibre is reasonably close to the centre of the conduit helps, for example, to reduce stress being applied to the fibre when the conduit is bent during installation, and to reduce the effects of vibration and other environmental influences on the optical fibre.

In FIG. 3, the conduit is further protected by an optional external metal braid 34 surrounding the conduit 30.

The granular material 32 may be selected to meet one or more of several conditions. Firstly, the granular material should not change its structure or consistency over the entire operating and storage environmental conditions that the sensor may be exposed to. For example, the granular material should not melt when exposed to the temperature range of the sensor.

Secondly, the granular material should not react or form any bonds with any of the materials it is in contact with during exposure to the entire operating and storage temperature ranges of the sensor, including with the optical fibre 14, and in particular with coatings of that optical fibre. For example, it is generally accepted that silica optical fibre requires a non-silica coating in order to guarantee its long-term integrity. The conventional coating material is acrylate usually with a maximum continuous operating temperature of around 85° C. Alternative coating materials may be used for higher temperature applications. Multiple layers of different coatings can also be employed. For example, a thin layer of carbon may be deposited first to provide a hermetic seal, followed by a polyimide coating.

Table 1 lists some of the known coating materials for optical fibres together with their typical maximum continuous operating temperatures. For temperature applications above 300° C. a metal coating is typically required and for operations above 450° C. a gold coating is the preferred choice. Hence, for application in a high-temperature sensor such as that of FIG. 1 or 2, a granular material should be chosen that does not react with a metal coating of the optical fibre 14. Similarly, the granular material should not react with the material used to form the conduit, and in particular an inside surface of the conduit, such as Inconel or stainless steel material.

TABLE 1

| Coating material for optical | Maximum continuous |
|---|---|
| fibre | operating temperature |
| Acrylate | +85° C. |
| High temperature Acrylate | +150° C. |
| PEEK | +230° C. |
| Polyimide | +300° C. |
| Aluminium | +400° C. |
| Copper | +450° C. |
| Gold | +700° C. |

Thirdly, the coefficient of thermal expansion (CTE) of the granular material should preferably be between the CTE of the optical fibre and the CTE of the conduit material. That way the introduction of the granular material will not exacerbate the thermal mismatch between optical fibre and conduit.

Fourthly, the filler material should have non-binding properties in the possible presence of moisture, such as exposure to moisture during assembly or in circumstances when the conduit does not have to be hermetically sealed during operation. In such circumstances, the granular material should dry out without solidifying when exposed to heat.

A powder or other granular material filler meeting above requirements may consist of a suitable high-temperature ceramic granulate. For instance, a preferred ceramic granulate may comprise or be made of Alumina Al₂O₃ which has a melting point of around 2072° C. Other suitable granular materials such as MgO, HfO₂ or SiO₂ are also listed in Table 2.

TABLE 2

| | | Maximum use | |
|---|---|---|---|
| Granular | Melting point | temperature | CTE |
| material | (° C.) | (° C.) | (×10⁻⁶/° C.) |
| Al₂O₃ | 2072 | 1750 | 8.4 |
| MgO | 2852 | 1976 | 10.8 |
| HfO₂ | 2758 | 2400 | 6.0 |
| SiO₂ | 1070 (strain point) | 1100 | 0.54 |
| | 1140 (annealing point) | | |

The granularity of the granular filler material may be chosen to be within certain ranges. For instance, using a material with a granularity comparable or larger than the size of the optical fibre external diameter may create undesirable mechanical deformations and potential damage to the fibre when bending the conduit. A typical single-mode optical fibre has a cladding diameter of 125 μm; hence a preferred upper limit of granularity may be of the order of 50 μm. Some embodiments described below may employ fibre of a larger than 125 μm diameter. In that case the upper granularity limit would scale accordingly, at 40% of the fibre diameter in line with the value for a 125 μm diameter fibre. Thus, for example, a 200 μm or 250 μm diameter fibre could result in a suitable granularity of up to about 80 μm or 100 μm, respectively, and optionally up to about 200 μm. On the other hand, employing a material with a very fine or small granularity will lead to practical difficulties in filling longer sections during assembly. Particle size should also facilitate free movement of the fibre axially and free forming of the conduit. A suitable lower limit of the granularity of the material may therefore be 10 μm or 30 μm. The lower limit is largely independent of the fibre diameter.

When considering powder granularity, one needs to account for the fact that commercially available powders usually contain a range of particle sizes. Granularity may therefore be characterised by statistical means such as the percentile Dx, which refers to the maximum particle size or diameter D below which x % of the population belongs to. For example, D50 is commonly known as the median particle size, meaning that 50% of the particles in the population have a size or diameter smaller than D50. It follows that the remaining 50% of particles of the population will have a size or diameter (equal to or) greater than D50. Accordingly, 90% of particles of the population have a maximum size or diameter less than the D90 value, and 90% of particles of the population have a size or diameter which is at least the D10 value.

Thus, a suitable granularity of the material, for example for a 125 μm (or 200 μm or 250 μm) diameter fibre may therefore be conveniently characterized by D10=30 μm (or at least 10 μm), and D90=40% of the fibre diameter (or no more than 50% of the fibre diameter), so D90=50 μm or 80 μm or 100 μm for 125 μm or 200 μm or 250 μm diameter fibre respectively. For a tighter size control, this could be set to D5=30 μm and D95=50 μm (80 μm or 100 μm).

On the above basis, a suitable range of granularity for material, for example in terms of a D50 or median particle size, may be said to be from about 30 μm to 80 μm, or more broadly from about 10 μm to 200 μm.

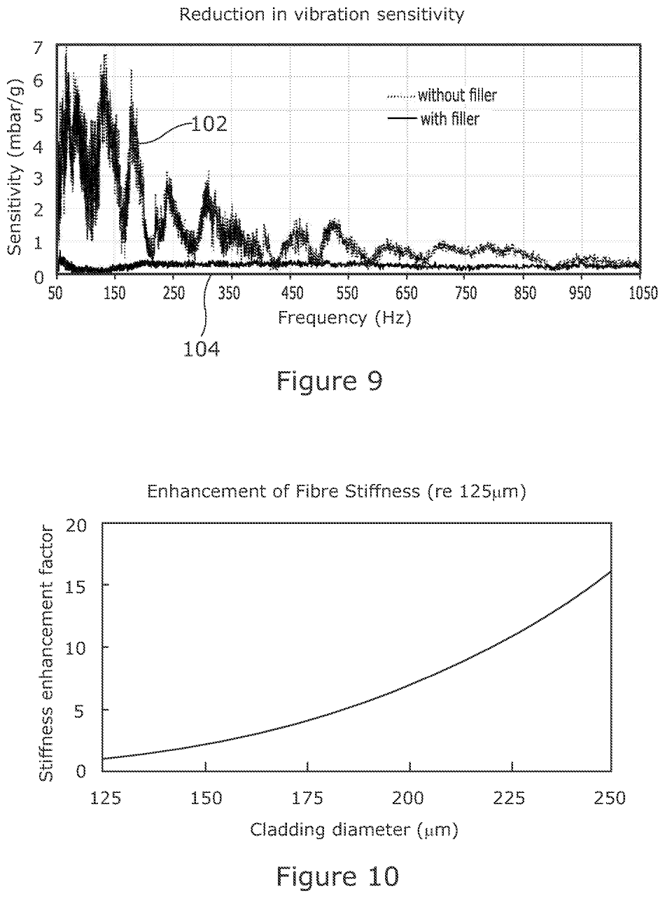

To demonstrate the effectiveness of using a granular material packed within the conduit, FIG. 9 shows the effects of vibration on the output of a pressure sensor employing an optical fibre 14 within a flexible metal conduit 30 both without any granular material filler (upper curve 102) and with the granular material packed within the conduit (lower curve 104) as shown cross section in FIG. 3. A dual wavelength type interrogation technique as discussed above was used.

For these measurements, the sensor head 16 arranged to measure local pressure was mounted on a vibration table that delivered a pre-set acceleration level across a chosen frequency band. Recording an AC output from the interrogator 24 which should represent true pressure changes at the sensor head, the sensitivity is calculated as the ratio of the apparent measured pressure to the applied acceleration. The arrangement without any granular material filler shows the considerable residual sensitivity to vibration seen in the upper curve 102, and is particularly pronounced in the low-frequency range. This is due to the fact that for a given acceleration level, the corresponding displacement is inversely proportional to the square of the vibration frequency, leading to increased fibre bending and associated optical attenuation effects at lower frequencies.

Employing a granular material filler in the conduit dramatically reduces the sensitivity to vibration as shown in the lower curve 104, by restricting lateral movement of the fibre within the conduit, resulting in a near flat response substantially below the 0.5 mbar/g mark across the entire frequency range.

FIG. 3 illustrates in cross section a conduit 30 in which the optical fibre 14 is embedded directly in the granular filler material which otherwise fills the cross section of the conduit. However, this arrangement is subject to a number of possible variations. For example, in the arrangement of FIG. 4, the optical fibre is first disposed within a sleeve 40, in particular a textile or flexible sleeve which is tolerant of high temperatures, and the sleeve is then surrounded by the granular material packed within the conduit between the sleeve and the walls of the conduit. This aspect of the invention may be implemented alone and even without use of the granular material, or with one or more of the other aspects described herein such as the use of granular material, the use of enhanced diameter cladding, and the use of a reduced mode field diameter or other fibre type to reduce bending losses.

In FIG. 4, the conduit, granular material, sleeve and optical fibre are substantially concentric, with advantages already discussed with respect to FIG. 3, but some deviation from this arrangement is of course possible for example with the optical fibre being for example within 10% of the conduit diameter from the central axis of the conduit, or as close to the central axis as reasonably practical subject to the techniques used to construct the arrangement shown.

Various suitable flexible high-temperature types of sleeving for this purpose are available in different grades of purity, based on, for example, quartz, fused silica or alumina silica with upper service temperatures in the order of ˜1000° C. However, using a flexible sleeve 40 with a coefficient of thermal expansion which is close to that of fused silica can help to minimize thermal expansion mismatch between the optical fibre 14 and the sleeve 40.

A suitable high-temperature sleeving may include braided or woven sleeving with a very high SiO₂ content of the order of ≥99.9%. Such sleeving is available, for instance, from Hitex Composites (Ningbo, China) or Textile Technologies Europe Ltd. (Cheshire, UK). A powder or other granular material filler is then used to completely fill the entire space between the flexible sleeve 40 which encloses the optical fibre 14 and the inside walls of the conduit 30, eliminating vibration induced lateral fibre movements within the conduit. For that reason, a close fit of the flexible sleeve 40 around the optical fibre may be desirable to avoid movement of the optical fibre within the sleeve. The granular material filler then restricts lateral fibre movements in the same way as without the flexible sleeve 40, but additional cushioning of the optical fibre is provided by the flexible sleeve compared to the situation of FIG. 3 where the optical fibre is directly in contact with the granular material.

If a flexible sleeve comprising a braided or woven material is used, then note that braided materials are available that may offer a smoother surface in the direction along the axis of the sleeve and of the optical fibre, thereby reducing friction between the optical fibre and the inner surface of the sleeve. This facilitates a smoother movement of the fibre in the axial direction when exposed to temperature variations and further minimises the risk of stress variations over time in the optical fibre.

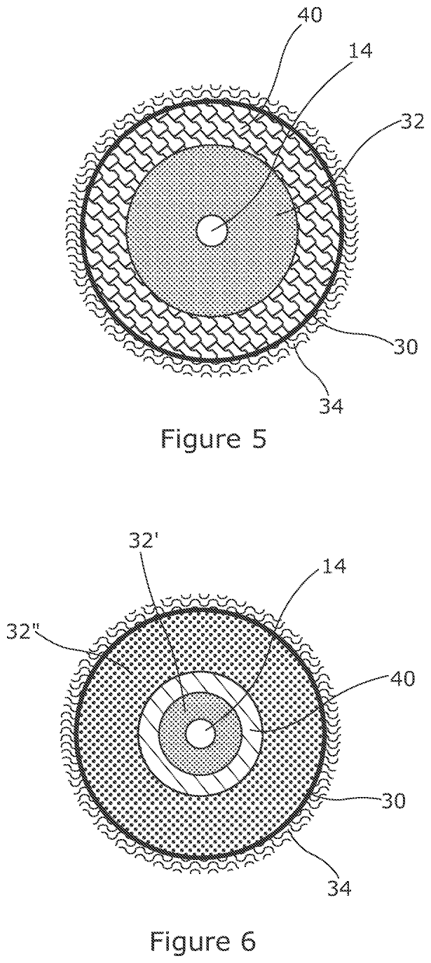

However, as an alternative to the arrangements of FIGS. 3 and 4, a granular material may instead by packed directly around the optical fibre but within the flexible sleeve 40, with the flexible sleeve then being adjacent to and/or in direct contact with the conduit. Such an arrangement is shown in FIG. 5. In this arrangement contact between the conduit and the granular material is avoided. The flexible sleeve in this arrangement may, however, facilitate increased flexibility of the conduit if bending is required for example during installation of the sensor.

As another alternative to the arrangements of FIGS. 3, 4 and 5, granular material may be packed both within the flexible sleeve and outside the flexible sleeve 40 as shown in FIG. 6. The inner granular material within the flexible sleeve, and therefore typically in contact with the optical fibre 14 is shown in FIG. 6 as inner material 32′. The outer granular material which is outside of the flexible sleeve and therefore typically in contact with the inside wall of the conduit 30 is shown as outer material 32″.

Similar to FIGS. 3 and 4, in FIGS. 5 and 6 the optical fibre, sleeve, and one or more regions of granular material are substantially concentric within the conduit, but some variation from this geometry is of course possible.

Although the same granular material with the same properties may be used for both the inner and outer granular materials, these may instead differ in one or more respects such as chemical composition, granular size distribution, thermal properties, and so forth. The use of at least two separate, and typically concentric regions of granular material therefore enables the selection of properties such as granularity and coefficient of thermal expansion (CTE) which are better matched to respective encapsulated or encapsulating materials and structures.

For example, the inner granular material 32′ may be selected to have a CTE that is closer to that of the optical fibre (typically made of silica). On the other hand, the outer granular material 32″ could be chosen such that it has a CTE that is closer to that of the conduit (typically formed of a metal such as Inconel or an austenitic stainless steel). To this end, the inner material would typically have a lower CTE than the outer material.

For example, the inner granular material 32′ could comprise or be a silica granulate having essentially the same or a very similar CTE as that of the optical fibre at around 0.5×10⁻⁶/° C., whereas the outer granular material could be or comprise an alumina granulate with a CTE of around 8.4×10⁻⁶/° C. that is closer to the CTE of a stainless steel 316 conduit material of around 15'10⁻⁶/° C.

Therefore using multiple concentric or at least multiple layers of different granular materials packed within the conduit, typically separated by one or more optionally concentric flexible sleeves, a more gradual change of coefficient of thermal expansion in the radial direction of the conduit can be created, easing effects of CTE mismatch between the central optical fibre 14 and the material of the surrounding conduit.

Alternatively, or in addition to the above multiple granular materials of different CTE, the inner material 32′ could consist of a finer grained granulate, for example with a smaller median grain size, than the outer material 32″. Use of a finer grained inner material may minimise indentation damage to a coating such as a metal coating of the optical fibre 14, while permitting a coarser grained outer material to be used for example to help provide improved flexibility of the conduit during installation.

Although FIGS. 3 to 6 are described as showing packing of one or more granular materials, with optional additional sleeving, around the optical fibre within the conduit, essentially the same or similar configurations may be used within or extend into other structures of the sensor, for example into the rigid section 42 of the sensor head, and the junction 36, which are illustrated in FIG. 2.

Similarly, the discussed configurations using granular material may be restricted to certain parts of sections of the conduit, for example being used only in flexible sections or only in rigid sections.

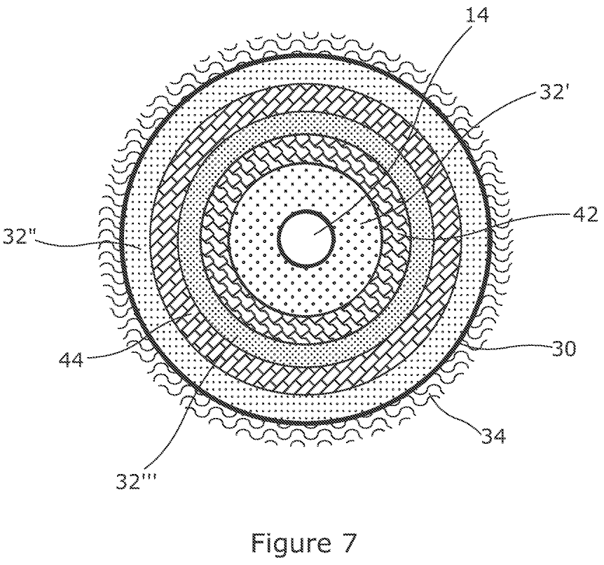

In FIGS. 4, 5 and 6 one layer of sleeving 40 within the conduit is shown, but two or more such sleeving layers may be used, for example two such layers in contact with each other which may provide decreased friction to longitudinal movement of the optical fibre within the conduit, or two or more such layers with each pair of layers spaced by different region of granular material.

Where two or more such coaxial layers of sleeving are used, two or more of the layers may each be formed using a different textile construction type, such as using a different one of a woven, braided, and knitted textile material, each of which can have different properties and advantages as already discussed above. FIG. 7, for example, illustrates a variation of the construction of FIG. 6 in which two coaxial sleeves are used, one inside (and typically approximately concentric within) the other, with granular material packed all of: within the inner flexible sleeve 42, as material 32′, outside the outer flexible sleeve 44, as material 32″, and between the inner and outer flexible sleeves, as material 32″′.

Alternatively, any one, more than one, or all of the layers of granular material shown in FIG. 7 may be omitted if desired. For example, FIGS. 8a and 8b illustrate another construction in which two coaxial (i.e. one inside the other), and typically approximately concentric, layers of sleeving are used, without any packed granular material. In such an arrangement, the textile construction or other material types of each sleeve may be different and chosen to fulfil particular design functions.

By way of example, in FIG. 8a the outer sleeve 44 may be a braided or knitted sleeve formed of strands with a relatively larger diameter, arranged to fill a majority of the diameter between the optical fibre 14 and the conduit 30. Employing larger diameter strands in a layer of sleeving may however cause undue deformations of the optical fibre if used to directly enclose the optical fibre, and especially if packed tightly to avoid lateral movement of the optical fibre. Such undue deformations could weaken the fibre or cause undesirable changes of its optical properties such as additional attenuation of the light propagating within the fibre.

This deformation problem can be avoided by providing the illustrated inner sleeve 42 between the optical fibre 14 and the outer sleeve, the inner sleeve having a different textile construction to that of the outer sleeve, for example being a woven material sleeve, and being formed of strands with a relatively smaller diameter compared to those of the outer sleeve. Such an inner woven sleeve will typically have a somewhat greater stiffness than an outer braided or knitted sleeve, and can thereby provide sufficient protection to the optical fibre 14 from deformation caused by the larger strands of the outer sleeve, while the outer sleeve 44 provides the required volume to fill the majority of the space between optical fibre and the conduit 30 at sufficient density to providing the required mechanical damping to restrict or prevent lateral movement of the optical fibre within the conduit.

On the other hand, if a braided sleeve layer is made of sufficiently soft strands, the risk of deformation of the optical fibre if in contact with such a layer may be negligible, and it may be beneficial to first enclose the optical fibre within an inner braided sleeve layer 46 followed by a woven outer sleeve layer 48 as illustrated in FIG. 8b. Such an arrangement could facilitate a smoother movement of the optical fibre in the axial direction when exposed to temperature variations, because braided materials are available that offer a smoother surface in the direction along the axis of the sleeve and of the optical fibre, thereby reducing friction between the optical fibre and the inner surface of the sleeve. The outer, woven sleeve layer 48 will then provide some additional stiffness, helping with the desired reduction of lateral movement.

Although in FIGS. 8a and 8b just two coaxial flexible sleeve layers are shown, these embodiments may be adapted to comprise more than two such layers, with the layers being formed from any suitable combination of same or different textile construction types and other properties.

In some embodiments, the optical fibre along each of two or more different elongate sections of the conduit may be surrounded by a different combination of one, two or more coaxial sleeves. Each such coaxial sleeve combination may use the same or a different number of coaxial sleeves as the other sleeve combinations, and the sequence of textile construction types for the coaxial sleeves may vary between the sleeve combinations.

In some embodiments, all of the different coaxial sleeve combinations used for different elongate sections of the conduit may comprise at least two coaxial sleeve layers. For example, an inner woven sleeve and outer knitted sleeve could be used together for a portion of the conduit of larger internal diameter, and an inner woven sleeve and outer braided sleeve could be used for a portion of the conduit with smaller internal diameter. Referring to FIG. 2 for example, a rigid section 42 of the conduit may have a different internal diameter to a flexible section of the conduit. Use of different coaxial sleeve combinations in different elongate sections of the conduit provides different filling factors to be implemented in the different sections to ensure that the space within the conduit is adequately filled (even in absence of any granular packing material), to ensure that lateral movement of the optical fibre within different sections of the conduit is suitably restricted or prevented.

The inventors have also observed that an increased stiffness of the optical fibre 14 tends to reduce vibrationally induced movements of the optical fibre, and leads to a suppression of vibration and other environmentally induced artefacts and biases in the interference signal therefore providing more accurate determination of the one or more measurands, and that such increased stiffness can be achieved by increasing the outside diameter of the optical fibre cladding. For example, the optical fibre 14 within the conduit 30 may have an increased outside cladding diameter of at least 150 μm, or of at least 200 μm, or of at least 250 μm. This outside cladding diameter typically does not include any further protective layers such as non-silica coatings. This aspect of the invention may be implemented alone, or with one or more of the other aspects such as the use of granular material, the use of one or more protective sleeves, and the use of a reduced mode field diameter or other fibre type to reduce bending losses.

Single-mode optical fibre commonly used in the prior art typically consists of a 9 μm diameter Germanium oxide (GeO₂) doped silica core in the centre of a 125 μm diameter pure silica cladding. Germanium oxide doping is used to slightly raise the refractive index of the optical core, creating a step-index profile. Light that is guided by the fibre is predominantly contained within the core region of the fibre and tails off exponentially into the cladding region. Increasing the cladding diameter of the fibre will therefore not tend to affect the light guiding properties of the fibre.

Mechanically, the fibre can be considered as a homogeneous solid rod made of silica with a diameter D equal to the outside cladding diameter. The stiffness or resistance to flexural deformation is proportional to the area momentum of inertia I given by:

$$I = π {D}^{4} / 64 \qquad ( 1 )$$

To illustrate the achievable stiffness enhancement compared to a 125 μm diameter standard single-mode optical fibre, the momentum of inertia is plotted in FIG. 10 as a function of fibre outside cladding diameter D, normalized to that of a 125 μm diameter fibre.

To arrive at a suitable outside cladding diameter, a trade-off between desirable increased stiffness, and routing requirements of the conduit 30 during installation for a given application, can be considered. For instance, the maximum enhanced stiffness should be such that it still guarantees a minimum bending radius of the conduit 30 required for routing purposes. For many applications, an approximate fifteen-fold increase in optical fibre stiffness over a conventional 125 μm optical fibre, appears to be a suitable upper limit. On the other hand, a doubling in stiffness in comparison to a standard 125 μm fibre might be considered as a minimum requirement to obtain a noticeable reduction of vibration induced artefacts and biases in the interference signal.

According to the curve shown in FIG. 10, an outside cladding diameter of at least 150 μm, or of at least 200 μm, may therefore be desirable. To retain suitable flexibility however, an outside cladding diameter of no more than 250 μm may also be desirable.

A single-mode optical fibre with an outside cladding diameter larger than the standard 125 μm size can be manufactured via the usual drawing process but using a tailor made optical preform replicating the cross-sectional fibre geometry and doping profile of the fibre to be drawn. During the fibre drawing process the corresponding core-cladding diameter ratio and doping profile remains unchanged. Hence, if for example, a single-mode fibre with a core diameter of 9 μm and a cladding diameter of 200 μm is required, a preform with the same equivalent core to cladding ratio of 9 μm/200 μm=0.045 is required.

For deployment of the sensor in a high temperature environment a suitable coating that can withstand those temperatures should be applied to the enhanced diameter cladding of the optical fibre 14. According to table 1 above, for temperatures above about 300° C. the preferred choice is a metal coating. For applications above about 450° C. the preferred choice is a gold coating. Advantageously, methods such as ‘liquid freezing’ described for example, in U.S. Pat. No. 6,600,863 and V. A. Bogatyrev, S. Semjonov “Metal-Coated Fibers”, Chapter 15, Specialty Optical Fibers Handbook, A. Mendez, T. F. Morse (ed), Elsevier 2007, are equally applicable to fibres with cladding diameters in the range from 150 μm, or from 200 μm, to 250 μm or above to provide a metal coating during the drawing process.

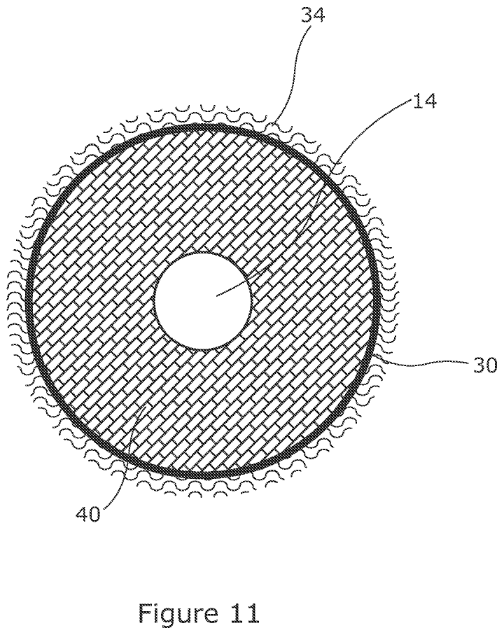

Although an optical fibre 14 having a cladding with increased outside diameter may be used in the context of the various arrangements described above and illustrated in FIGS. 1-7, in which a granular material packed into the conduit restricts or prevents lateral movement of the optical fibre within the conduit, the increased cladding diameter may also be used in arrangements in which the granular material is omitted for example in the arrangements of FIGS. 8a, 8b and 11.

FIG. 11 shows such an arrangement in which the conduit 30 is still optionally surrounded by a protective braided metal sheath 34, and in which the optical fibre 14 is contained within the conduit as already described above. However, in this arrangement the optical fibre 14 is optionally contained within the a flexible sleeve 40, but without any granular material present. The sleeve 40 may have the various characteristics and properties already discussed above, for example being a flexible sleeve such as a braided, knitted, or woven silica sleeve. The sleeve 40 then provides support of the optical fibre 14 within the conduit, helping to restrict or prevent lateral movement of the optical fibre within the conduit, and thereby reducing artefacts and biases in the interference signal which would otherwise give rise to errors in the one or more measurands.

Note that for arrangements where no granular material is packed or filled into the conduit, a conduit of reduced inside (and optionally outside) diameter may be used, for example having a diameter in the range 1 mm to 5 mm. The chosen diameter may depend for example on the properties of any sleeve or sleeves 40 being used to support the optical fibre 14 within the conduit 30.

The inventors have also observed that using an optical fibre 14 in which the effects of fibre bending on light propagation are reduced, tends to reduce the effect of vibration and other artefacts and biases in the interference signal, and therefore provides more accurate determination of the one or more measurands. The inventors have also noted that such a reduction can be achieved by using an optical fibre with a reduced mode field diameter. This particularly applies where the optical fibre 14 is, or is acting in respect of the probe light as, a single mode optical fibre. This aspect of the invention may be implemented alone, or with one or more of the other aspects such as the use of granular material, the use of one or more protective sleeves, and the use of an enhanced cladding outside diameter.

Whereas a typical single mode fibre carrying light at around 1550 nm wavelength displays a mode field diameter of around 10.6 μm, use of an optical fibre within the conduit 30 having a mode field diameter of no more than 10.0 μm, or of no more than 8.0 μm, or in the range from 6.0 μm to 8.0 μm, for example at a central (for example a peak or average) wavelength of the probe light, may therefore be advantageous in improving accurate determination of the one or more measurands. The reduced bending losses and therefore reduce artefacts and biases which can be achieved in this way can be understood to result from a stronger confinement of the optical mode or modes of the probe light within the optical fibre.

For a single-mode, step-index optical fibre the mode field diameter (MFD) is approximately given by D. Marcuse, “Loss analysis of single-mode fiber splices”, Bell Sys. Tec. J. 56(5):703-18 (1977):

$$MFD = 2 α ( 0. 65 + 1.6 \; 19 / {V}^{3 / 2} + 2.8 \; 79 / {V}^{6} ) \qquad ( 2 )$$

with α and V denoting the radius of the fibre core and the normalized frequency, respectively. The normalized frequency V is defined as:

$$V = NA 2 πα / λ \qquad ( 3 )$$

and the fibre is single-moded if V<2.405. In the above equation NA denotes the numerical aperture:

$$NA = {( {n}_{c}^{2} - {n}_{cl}^{2} )}^{1 / 2} \approx {( 2 {n}_{cl} Δ n )}^{1 / 2} \qquad ( 4 )$$

n_{c} and n_{cl} are the refractive indices of the fibre core and fibre cladding, respectively, Δn=n_{c}−n_{cl}, and λ is the vacuum wavelength of the light guided in the fibre.

From the above equations it follows that, at a given operating wavelength, the MFD depends on the core radius α and the difference Δn between core and cladding refractive indices characterized by the numerical aperture NA.

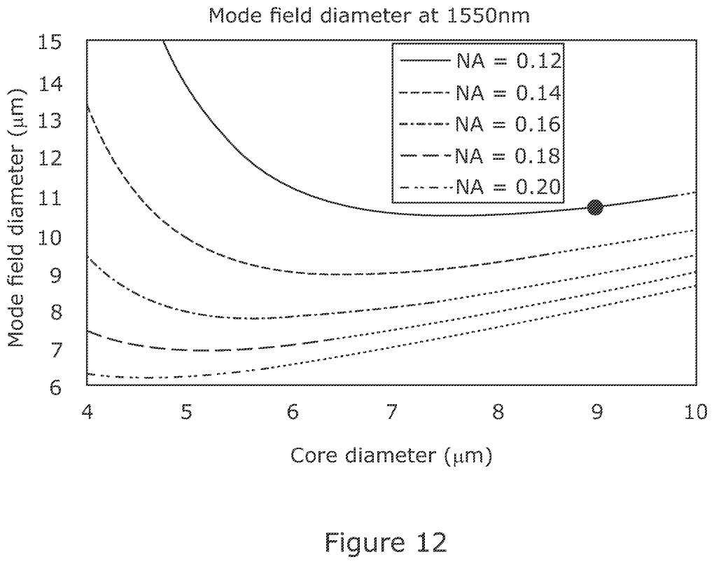

In FIG. 12 the MFD of the fundamental mode is plotted as a function of core diameter 2α for different values of NA at a typically suitable probe light wavelength of 1550 nm. The dotted lines indicate the regions where the optical fibre 14 carries more than one optical mode in accordance with V>2.405, i.e. ceases to be single-moded. A typical step-index single-mode fibre may have a core diameter of 9 μm, an MFD of 10.6 μm and an NA of 0.12, as indicated by the dot.

Reducing the core diameter of a fibre with NA=0.12 will initially lead to a modest reduction in MFD before the mode is ‘squeezed out’ of the core and becomes rapidly less guided, characterized by an increase in MFD. A larger reduction in MFD can be achieved by increasing the difference between core and cladding refractive indices, indicated by the lower curves in FIG. 10 representing larger NAs. Interferometry based optical sensors typically require a single-mode fibre to carry the probe light. Hence, as can be seen from FIG. 12, an increase in NA also requires a reduction of the core diameter to stay within the single-mode regime of the fibre.

Accordingly, in order to reduce errors in the one or more measurands, the optical fibre 14 of the present sensor may be provided with a core diameter of from 5 μm to 7 μm and a NA in the range from 0.16 to 0.20, yielding an MFD for probe light of around 1550 nm of between about 6 μm and 8 μm.

More generally however, and noting that the MFD is somewhat dependent on probe light wavelength, an MFD of less than 10 μm, or of less than 8 μm, or of from 6 μm to 8 μm, may be considered advantageous, where these values and ranges may be taken as specified at a central (for example peak or average) wavelength of the probe light. Such a central wavelength could for example be taken as a main or principle peak in the intensity or power of the probe light or average of two or more main or principle peaks, or as an average wavelength with respect to intensity or power over wavelength, or in other suitable ways

A value of NA=0.16 might also or instead be considered as a minimum to provide a noticeable reduction of vibration induced effects due to bending.

Note that although probe light of about 1550 nm is used in the example of FIG. 10, the proposed values and ranges of mode field diameter may equally be applicable where the probe light has a wavelength in a near infrared range of about 1300 to 1800 nm or about 1400 to 1700 nm.

An optical fibre 14 with a core diameter between 5 μm and 7 μm and an NA value between 0.16 and 0.20, or with other ranges of properties to provide a reduced mode field diameter, may be manufactured by preparing a preform with the same desired reduced core-to-cladding diameter ratio as the fibre, as this ratio is maintained during the process of drawing the fibre from the preform. For example, for a standard single-mode optical fibre with core and cladding diameters of 9 μm and 125 μm, respectively, the required preform ratio equals 9 μm/125 μm=0.072. To draw a fibre with core and cladding diameters of 6 μm and 125 μm, respectively, a preform with a ratio of 6 μm/125 μm=0.048 is required.

Increasing the NA of the optical fibre 14, so as to achieve a smaller mode field diameter, can be achieved by increasing the doping concentration and/or by altering the doping profile of the preform. In a standard single-mode fibre, the silica core is typically doped with Germanium oxide (GeO₂), slightly raising the refractive index of the core and creating a step index profile. The cladding material is typically undoped pure silica with n_{cl}=1.46. For example, for a fibre with NA=0.12, the index difference equals Δn=(NA)²/2n_{cl}≈0.005.

A higher index difference between core and cladding and therefore a larger NA can be achieved by increasing the concentration of the Germanium dopants in the core. For example, to achieve a NA of 0.16, the difference in index must be raised to approximately Δn≈0.009. Alternatively, or in addition, the cladding can be doped with a suitable doping material that reduces the refractive index of silica, leading to a larger index difference between core and cladding indices. An example of such suitable dopant may be Fluorine.

As an alternative method to reduce vibration induced bending losses and associated undesirable artefacts and biases, a more complex doping profile could be employed. For example, U.S. Pat. No. 6,901,196 which is hereby incorporated by reference for these and all other purposes, describes a suitable optical fibre with a multi-layered core region, containing an annular trench of depressed index surrounding a first core with a raised step-index profile. Other suitable optical fibre types to achieve similar effects include photonic bandgap fibres and average index guided fibres, each of which use a different light guiding mechanism and can be used to achieve lower bending losses without necessarily reducing the mode field diameter.

Although an optical fibre 14 having a reduced mode field diameter may be used in the context of the various arrangements described above and illustrated in FIGS. 1-11, in which a granular material packed into the conduit and/or one or more flexible sleeves restrict or prevent lateral movement of the optical fibre within the conduit, and/or an increased cladding diameter is used to increase optical fibre stiffness, the reduced mode field diameter aspect may also be used in arrangements in which the granular material is omitted, and there is no enhancement in the cladding diameter. If an arrangement is used without any granular material, whether or not an increased fibre stiffness is used, the conduit 30 may still be optionally surrounded by a protective braided metal sheath 34, and the optical fibre 14 will be contained within the conduit as already described above and may also be contained within one or more sleeves 40 within the conduit as discussed above.

Note that for arrangements where no granular material is packed or filled into the conduit, a conduit of reduced inside (and outside) diameter may be used, for example having a diameter in the range 1 mm to 10 mm. The chosen diameter may depend for example on the properties of any sleeve 40 being used to support the optical fibre 14 within the conduit 30.

The sensors described above may be used to implement sensing of time-varying, or “dynamic” pressure, which is often used to detect or monitor combustion instabilities in gas turbines. Developing combustion instabilities typically manifest themselves as self-amplifying pressure oscillations at a frequency range of up to about 10 kHz, with frequency components of up to about 20 kHz frequently being of interest.

Typically, the analyser 22 may apply a fast Fourier transform to a time series of a dynamic pressure measurand signal, and combustion instabilities are then detectable as pressure peaks in the frequency domain. According to the Sampling Theorem, a signal frequency of 20 kHz requires a minimum update rate of 40 kHz. Hence, preferably a fast interrogation technique such as, for example, the dual wavelength interrogation scheme described in A. Winterburn et al., “Extension of an optical dynamic pressure sensor to measure temperature and absolute pressure in combustion applications”, The Future of Gas Turbine Technology, 6th International Conference, 17-18 Oct. 2012, Brussels, Belgium, Paper ID Number: 15, may be employed by the interrogator 24 to achieve a sufficiently high update rate. The contents of this document are hereby incorporated by reference for these and all other purposes.

Artefacts due to vibration of the optical fibre 14 within the conduit 30 may then appear as additional peaks in the frequency domain and may be mistaken as pressure oscillations relating to combustion instabilities if not sufficiently suppressed. The techniques described can be used to adequately suppress such vibration-induced artefacts, enabling the detection of combustion instabilities with high confidence. Preferably, such vibration induced artefacts are suppressed to levels below 0.5 mbar/g in the dynamic pressure measurand signal.

More generally, the described sensors may be mounted on the core of a gas turbine engine, which comprises compressor, burner, and turbine, or on the exhaust of such an engine, and can be arranged to measuring temperature and/or dynamic pressure and/or static or quasi-static pressure.

Although a dual wavelength interrogation scheme along the lines mentioned above may be used by the interrogator 24, it will be appreciated that the described sensors can also be deployed using other schemes, for example in which the measurands are encoded onto the probe light at the sensor head 16 by modifying, for example the phase or the polarisation of the probe light.

It will be further appreciated that the above mentioned dual wavelength interrogation schemes can be regarded as special cases of more general multi-wavelength interrogation techniques which can be used by the interrogator 24. For example, spectral interrogation techniques may employ a broadband probe light source 10 emitting light over a range of wavelengths such as, for example, a Super luminescent Light Emitting Diode (SLED). The interference signal is then encoded in the spectrum of the probe light that is reflected back from the sensor head 16. Methods such as those described in WO2013/136071 may be used to extract the one or more measurands from the returned spectrum. Typically, a spectrum analyser comprising a dispersive element may then be used to discern the individual wavelength components. Alternatively, implementing the probe light source 10 using a tunable laser sweeping through individual wavelength components in time, in conjunction with a photo diode at the optical detector 20, can be employed.

For spectral interrogation techniques, a suitable wavelength range for the probe light could be between about 40 nm and 80 nm, centered around a near infrared central wavelength such as 1550 nm. A suitable spectrum analyser could then use 512 or 1024 pixels to provide the wavelength range for detection if a broadband probe light source is being used, or if a tunable laser is being used then hundreds or thousands of wavelength points can be defined by suitable detection timing with respect to the tuning of the laser.

Although specific detailed embodiments of the invention have been described, the skilled person will appreciate that modifications and variations on these can be carried out without departing from the scope of the invention as defined by the appended claims.

For example, although some embodiments have been described with reference to sensing pressure using an optical cavity in the sensor head, embodiments are neither restricted to pressure sensors nor to a transducer element 44 comprising only a single optical cavity. Rather, transducer elements may contain multiple, spatially separated or spatially overlapping optical cavities responding to different measurands or responding to the same measurand. For example, techniques for the measurement of temperature and acceleration using a dual cavity transducer element as described in WO2013/136071, or for measuring temperature at two spatially separated positions within the transducer may be used.

Although the described embodiments implement a single conduit 30 carrying a single optical fibre 14 from a sensor head 16 to junction 36, with the same optical fibre 14 carrying probe light from the interrogator to the sensor head and back again in a reflective geometry, other geometries may be used. For example, some embodiments of the invention may provide sensors that operate in a transmissive mode so that probe light arriving at the sensor head continues through the sensor head to emerge carrying the interference signal into a different optical fibre 14 carried in the same or a different conduit 30. In this way, a plurality of conduits as described above could be implemented to connect a plurality of sensor heads in series, with the option of the probe light from all of the series sensor heads being returned for analysis to the same interrogator.

Although the described embodiments largely refer to just one optical fibre being carried in a conduit, two or more optical fibres could be carried in a single conduit. For example, a different optical fibre could be used to carry probe light to the sensor head, and back to the interrogator, or two optical fibres could each carry light to and from a single sensor head, or for other purposes.

1-21. (canceled)

22. An optical sensor for detecting one or more measurands, comprising:
a probe light source arranged to generate probe light;
a sensor head arranged to receive the probe light from the probe light source and impose on the probe light an interference signal responsive to the one or more measurands;
an interrogator arranged to receive the probe light from the sensor head, measure the imposed interference signal, and determine the one or more measurands from the measured interference signal;
one or more flexible sleeves disposed within the conduit; and
an optical fibre arranged to carry the received probe light at least some of the way from the sensor head to the interrogator, the optical fibre being disposed within the one or more flexible sleeves.

23. The optical sensor of claim 22 wherein each of the one or more flexible sleeves comprises one of a braided, a woven, and a knitted material.

24. The optical sensor of claim 22 wherein each flexible sleeve comprises a silica material.

25. The optical sensor of claim 22 wherein the one or more flexible sleeves comprise at least two coaxial flexible sleeves.

26. The optical sensor of claim 25 wherein at least two of the two coaxial flexible sleeves are formed using different textile construction types, optionally selected from woven, braided, and knitted textile construction types.

27. The optical sensor of claim 26 wherein an inner one of the coaxial flexible sleeves is formed from a woven textile material and an outer one of the coaxial flexible sleeves is formed from a knitted or braided textile material, or wherein an inner one of the coaxial flexible sleeves is formed from a braided textile material and an outer one of the coaxial flexible sleeves is formed from a woven textile material.

28. The optical sensor of claim 22 wherein the conduit comprises a plurality of elongate sections through which the optical fibre passes, wherein for each elongate section the optical fibre is disposed within a different combination of two or more coaxial flexible sleeves which are disposed within the conduit, each sleeve of each combination being of a particular textile construction type, each different combination comprising a different sequence of two or more such textile construction types.

29. The optical sensor of claim 22, wherein the optical fibre comprises a cladding having an outside diameter of at least 150 μm, or of at least 200 μm, or of at least 250 μm.

30. The optical sensor of claim 22 wherein the optical fibre has a mode field diameter of no more than 10.0 μm, or no more than 8.0 μm, or in the range 6.0 μm to 8.0 μm, at a central wavelength of the probe light, and/or
wherein the optical fibre has a core diameter of from 5 μm to 7 μm, and a numerical aperture of from 0.16 to 0.20.

31. An optical sensor for detecting one or more measurands, comprising:
a probe light source arranged to generate probe light;
a sensor head arranged to receive the probe light from the probe light source and impose on the probe light an interference signal responsive to the one or more measurands;
an interrogator arranged to receive the probe light from the sensor head, measure the imposed interference signal, and determine the one or more measurands from the measured interference signal; and
an optical fibre arranged to carry the received probe light at least some of the way from the sensor head to the interrogator, wherein the optical fibre comprises a cladding having an outside diameter of at least 150 μm, or of at least 200 μm, or of at least 250 μm.

32. The optical sensor of claim 31 wherein the optical fibre is disposed within a protective conduit.

33. The optical sensor of claim 31 wherein the optical fibre has a mode field diameter of no more than 10.0 μm, or no more than 8.0 μm, or in the range 6.0 μm to 8.0 μm, at a central wavelength of the probe light, and/or
wherein the optical fibre has a core diameter of from 5 μm to 7 μm, and a numerical aperture of from 0.16 to 0.20.

34. An optical sensor for detecting one or more measurands, comprising:
a probe light source arranged to generate probe light;
a sensor head arranged to receive the probe light from the probe light source and impose on the probe light an interference signal responsive to the one or more measurands;
an interrogator arranged to receive the probe light from the sensor head, measure the imposed interference signal, and determine the one or more measurands from the measured interference signal; and
an optical fibre arranged to carry the received probe light at least some of the way from the sensor head to the interrogator, wherein the optical fibre has a mode field diameter of no more than 10.0 μm, or no more than 8.0 μm, or in the range from 6.0 μm to 8.0 μm, at a central wavelength of the probe light.

35. The optical sensor of claim 34 wherein the optical fibre has a core diameter of from 5 μm to 7 μm, and a numerical aperture of from 0.16 to 0.20.

36. The optical sensor of claim 22 wherein the probe light source comprises one or more lasers, or one or more super-luminescent diodes, arranged to generate the probe light.

37. The optical sensor of claim 22 wherein the sensor head comprises one or more optical cavities arranged to impose the interference signal on the probe light responsive to the one or more measurands.

38. The optical sensor of claim 37 wherein the one or more optical cavities comprise one or more Fabry-Perot cavities.

39. The optical sensor of claim 22 wherein the optical fibre is a single mode optical fibre.

40. The optical sensor of claim 22 wherein the one or more measurands comprise one or more of: temperature, pressure, and acceleration, at the sensor head.

41. The optical sensor of claim 22 wherein the interrogator is arranged to separately detect the intensities of two different wavelengths of the probe light received from the sensor head, and to determine one or more of the one or more measurands responsive to a relationship between the detected intensities of the two wavelengths.

42. The optical sensor of claim 22 wherein the interrogator comprises a spectral engine arranged to measure an interference spectrum comprising the imposed interference signal, and is arranged to determine one or more of the one or more measurands from the measured interference spectrum.

43. A gas turbine engine comprising the optical sensor of claim 22, the optical sensor being arranged to detect combustion instabilities in the gas turbine engine.

44. (canceled)

45. (canceled)

46. A method of providing an optical sensor for detecting one or more measurands, comprising:
providing an optical fibre to couple probe light from a sensor head to be received by an interrogator that is arranged to measure an interference signal imposed on the probe light by the sensor head responsive to the one or more measurands;
providing one or more flexible sleeves and disposing at least a portion of the optical fibre in the one or more flexible sleeves; and
locating the one or more flexible sleeves within a protective conduit.

47. The method of claim 46 wherein the optical fibre is contained within the conduit for a distance in the range of 100 mm to 3000 mm from the sensor head along the optical fibre.

48. The method of claim 46 wherein at least a portion of the conduit comprises an elongate metal tube or corrugated metal hose.

49. (canceled)
